(19) United States
(12) Patent Application Publication
(10) Pub. No.: US 2020/0278989 A1
(43) Pub. Date: Sep. 3, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Takayuki YAMAMOTO, Kanagawa (JP); Yuki TAGAWA, Kanagawa (JP)

(73) Assignee: FUJI XEROX CO., LTD., Tokyo (JP)

(21) Appl. No.: 16/507,404

(22) Filed: Jul. 10, 2019

(30) Foreign Application Priority Data
Feb. 28, 2019 (JP) 2019-035780

(51) Int. Cl. G06F 16/33; G06F 16/335; G06F 16/332; G06F 16/901; G06F 16/31

(52) U.S. Cl. CPC G06F 16/3334; G06F 16/335; G06F 16/313; G06F 16/9024; G06F 16/3326

(57) ABSTRACT

An information processing apparatus includes a receiving unit receiving a query, an acquisition unit acquiring, on each content unit serving as a search target, multiple nodes corresponding to the query from data representing a relationship between the nodes and includes information on each node representing a concept of the content unit serving as a search target, a search unit searching for a path including mutually related nodes from the nodes acquired by the acquisition unit, and a calculating unit calculating a score of the path of at least one of the content units, the path searched and found by the search unit, by using at least one of a hop count representing a number of nodes included between a node representing the concept included in the query and the content unit, degree of importance of the concept of the content unit, and type of the relationship of the concepts.

### CROSS-REFERENCE TO RELATED APPLICATIONS

This application is based on and claims priority under 35 USC 119 from Japanese Patent Application No. 2019-035780 filed Feb. 28, 2019.

### BACKGROUND

### (i) Technical Field

The present disclosure relates to an information processing apparatus and a non-transitory computer readable medium.

### (ii) Related Art

Japanese Unexamined Patent Application Publication No. 8-137898 discloses a document retrieval apparatus that extends a keyword in a searching operation by using a concept dictionary describing a concept relation between words and phrases. The document retrieval apparatus determines a location of a search keyword, input on a search keyword input unit, in a concept network. A keyword extension unit in the document retrieval apparatus searches for a phrase related to a determined phrase and uses a hit phrase as an additional keyword. A keyword priority order attachment unit in the document retrieval apparatus attaches a priority order to each keyword in accordance with the degree of relation of the keywords accumulated in a concept network. The document retrieval apparatus searches a search target document for a keyword by using a priority attached thereto. A search execution unit in the document retrieval apparatus calculates a count at which each keyword matches each of the words in the search target document and a document acquisition unit in the document retrieval apparatus scores the document in accordance with the match count. In accordance with the priority order, the document retrieval apparatus aggregates the documents scored according to each keyword. A document ranking unit in the document retrieval apparatus ranks the accuracy of each keyword.

A semantic search that understands an intention of a user and outputs search results is used as a technique of searching for a content unit, such as a document. The semantic search assesses uniformly concepts related to the content unit. If a large number of content units having a similar concept are present, it may sometimes be difficult to reflect the user intention on search results.

### SUMMARY

Aspects of non-limiting embodiments of the present disclosure relate to an information processing apparatus that reflects more the intention of a user on search results in content searching than when concepts related to the content are uniformly assessed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a receiving unit that receives a query, an acquisition unit that acquires on each content unit serving as a search target multiple nodes corresponding to the query from data that represents a relationship between the nodes and includes information on each node representing a concept of the content unit serving as a search target, a search unit that searches for a path including nodes mutually related to each other from the nodes acquired by the acquisition unit, and a calculating unit that calculates a score of the path of at least one of the content units, the path searched and found by the search unit, by using at least one of a hop count representing a number of nodes included between a node representing the concept included in the query and the content unit, a degree of importance of the concept of the content unit, and a type of the relationship of the concepts.

### BRIEF DESCRIPTION OF THE DRAWINGS

Exemplary embodiment of the present disclosure will be described in detail based on the following figures, wherein:

FIG. 1 illustrates an example of the configuration of a network system of an exemplary embodiment;

FIG. 2 is a block diagram illustrating an example of an electrical configuration of an information processing apparatus of the exemplary embodiment;

FIG. 3 is a block diagram illustrating an example of the functional configuration of the information processing apparatus of the exemplary embodiment;

FIG. 4 illustrates a query and knowledge graph of the exemplary embodiment;

FIG. 5 illustrates path searching and path assessment of the exemplary embodiment;

FIG. 6A illustrates an example of an abstraction path of the exemplary embodiment, FIG. 6B illustrates an example of a concretion path of the exemplary embodiment, and FIG. 6C illustrates an example of a mixture path including the abstraction path and the concretion path, and FIG. 6D illustrates a relation path of the exemplary embodiment;

FIG. 7A illustrates a score calculation method for the abstraction path of the exemplary embodiment, FIG. 7B illustrates the score calculation method for the concretion path of the exemplary embodiment, and FIG. 7C illustrates the score calculation method for the relation path of the exemplary embodiment;

FIG. 8A illustrates a score calculation method for a branch path of the exemplary embodiment and FIG. 8B illustrates a score calculation method for a merging path of the exemplary embodiment;

FIG. 9 is a flowchart illustrating an example of a process performed by a path assessment program of the exemplary embodiment; and

FIG. 10 illustrates a search result screen of the exemplary embodiment.

### DETAILED DESCRIPTION

Embodiment of the disclosure is described with reference to the drawings.

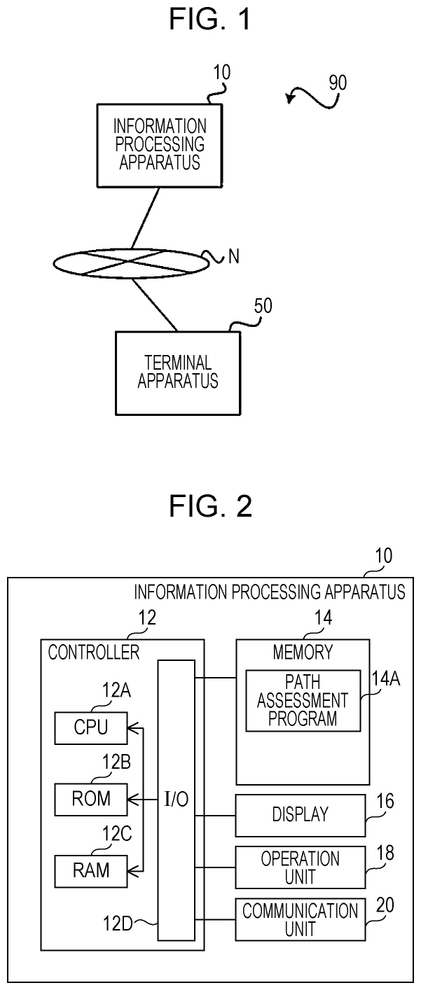

FIG. 1 illustrates an example of the configuration of a network system 90 of the exemplary embodiment. Referring to FIG. 1, the network system 90 of the exemplary embodiment includes an information processing apparatus 10 and a terminal apparatus 50. For example, a server computer, a personal computer (PC), or a general-purpose computer may be used for the information processing apparatus 10 of the exemplary embodiment.

The information processing apparatus 10 of the exemplary embodiment is connected to the terminal apparatus 50 via a network N. The network N includes the Internet, a local-area network (LAN), and/or a wide-area network (WAN). The terminal apparatus 50 of the exemplary embodiment includes a computer, such as a PC, a smart phone, or a tablet terminal.

The information processing apparatus 10 of the exemplary embodiment has a semantic search function. In response to a query input from the terminal apparatus 50, the information processing apparatus 10 acquires a content unit related to the query from among the content units serving as search targets, ranks the acquired content units as search results, and output the ranked content units.

FIG. 2 is a block diagram illustrating an electrical configuration of the information processing apparatus 10 of the exemplary embodiment. Referring to FIG. 2, the information processing apparatus 10 of the exemplary embodiment includes a controller 12, memory 14, display 16, operation unit 18, and communication unit 20.

The controller 12 includes a central processing unit (CPU) 12A, read-only memory (ROM) 12B, random-access memory (RAM) 12C, and input and output interface (I/O) 12D, and these elements are interconnected to each other via a bus.

The I/O 12D connects to function blocks including the memory 14, the display 16, the operation unit 18, and the communication unit 20. The function blocks are able to communicate with the CPU 12A via the I/O 12D.

The controller 12 may control part or whole of the operation of the information processing apparatus 10. Some or all of the blocks of the controller 12 may be implemented by a large-scale integration (LSI) chip or an integrated circuit chip set. Each block may be implemented by using an individual circuit or a partly or wholly integrated circuit. Some or all of the blocks may be integrated into a unitary block. In each block, part of the block may be separately arranged. The controller 12 may be integrated by using an LSI chip, a dedicated circuit or a general-purpose processor.

The memory 14 may include a hard disk drive (HDD), a solid state drive (SSD), or a flash memory. The memory 14 stores a path assessment program 14A that performs a path assessment process of the exemplary embodiment. The path assessment program 14A may be stored on the ROM 12B.

The path assessment program 14A may be installed on the information processing apparatus 10 in advance. The path assessment program 14A may be implemented by using a non-volatile storage medium having stored the path assessment program 14A, distributing the path assessment program 14A via the network N, or by appropriately installing the path assessment program 14A on the information processing apparatus 10. The non-volatile storage media may include a compact disc read-only memory (CD-ROM), magneto-optical disc, hard-disc drive (HDD), digital versatile disc read-only memory (DVD-ROM), flash memory, and memory card.

The display 16 may be a liquid-crystal display (LCD) or an electro-luminescence (EL) display. The display 16 may include a touch panel integrated therewithin. The operation unit 18 includes an operation input device, such as a keyboard or a mouse. The display 16 and the operation unit 18 receive a variety of instructions from the user of the information processing apparatus 10. In response to an instruction from the user, the display 16 displays results of a process performed in response to the received instruction and a variety of information, such as a notification about the process.

The communication unit 20 is connected to the network N such as the Internet, LAN, or WAN. The communication unit 20 communicates the terminal apparatus 50 via the network N.

As previously described, the concept related to the content unit is uniformly assessed in the semantic search. If the number of content units including a similar concept is relatively large, it may sometimes be difficult to appropriately reflect the intention of the user on the search results.

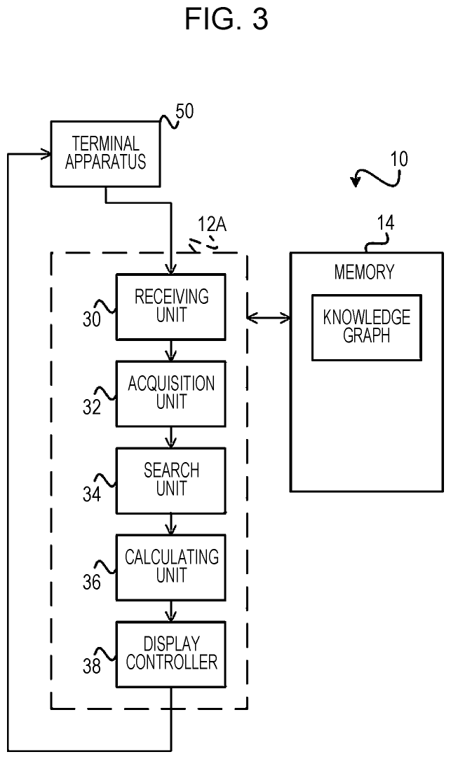

The CPU 12A in the information processing apparatus 10 of the exemplary embodiment operates as functional blocks in FIG. 3 by reading the path assessment program 14A from the memory 14 and writing the read path assessment program 14A onto the RAM 12C and then executing the path assessment program 14A.

FIG. 3 is a block diagram illustrating an example of the functional configuration of the information processing apparatus 10 of the exemplary embodiment. Referring to FIG. 3, the CPU 12A in the information processing apparatus 10 of the exemplary embodiment includes a receiving unit 30, acquisition unit 32, search unit 34, calculating unit 36, and display controller 38.

The memory 14 of the exemplary embodiment stores a knowledge graph. The knowledge graph is an example of data that represents a relationship between nodes and includes information on a node representing the concept of a content unit serving as a search target. The knowledge graph is also referred to as ontology. The knowledge graph is defined in advance on each content unit serving as a search target. In the knowledge graph, concepts are expressed in a layer structure. The content unit herein includes a document, an image (including a video) and/or audio.

The knowledge graph is defined by using a web ontology language (OWL) in a semantic web. The concept (also referred to as class) related to the knowledge graph is defined in a resource description framework (RDF) on which OWL is based. The knowledge graph may be a directed graph or an undirected graph. The presence of an object or a thing is expressed by assigning a concept representing physical or virtual presence to each node and by connecting the nodes with edges having labels different from type to type of relation of the concepts. The three entities including two concepts (nodes) and a relation (edge) between the two nodes are referred to as a “triple”.

The knowledge graph in use may include information on a property relation between the concepts in addition to the generic and specific relationship of the concepts. The generic and specific relationship represents a special relationship in which a generic concept includes all the entities falling within a specific concept. The generic concept is thus a concept broader than the specific concept. The property relation represents a relation that is freely definable outside the generic and specific relationship. A domain and a range are defined in the property. In the relationship of two nodes that form a triple with the property, the domain and range of the property restrict a range of value that each of a start point and an endpoint of a relation between the two nodes may take.

The receiving unit 30 of the exemplary embodiment receives a query from the terminal apparatus 50 used by the user. The query refers to information input by the user when a content unit is searched for.

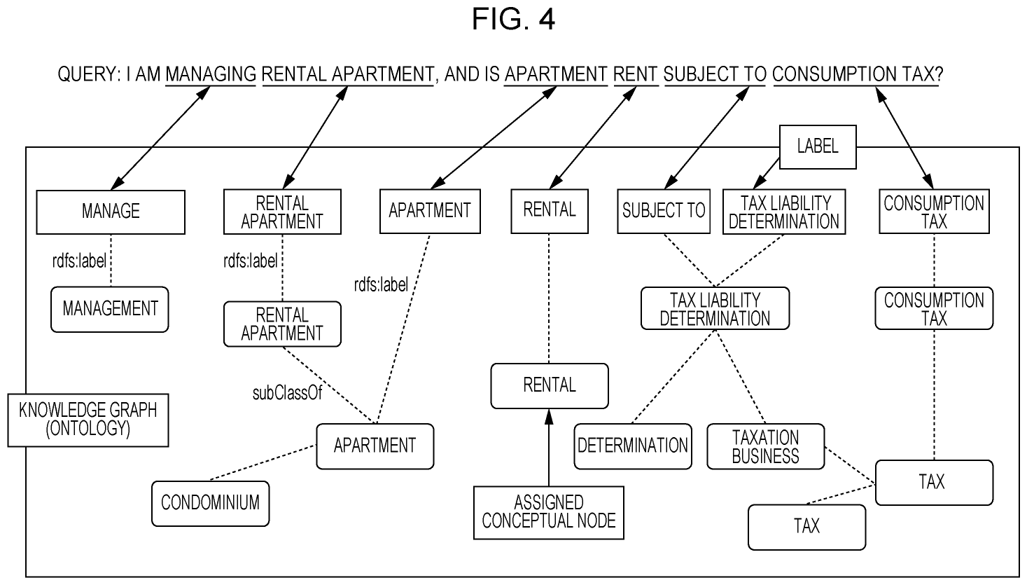

With respect to each content unit serving as a search target, the acquisition unit 32 of the exemplary embodiment acquires multiple nodes corresponding to the query from the knowledge graph stored on the memory 14 in FIG. 4.

FIG. 4 illustrates the query and knowledge graph of the exemplary embodiment. Referring to FIG. 4, the user enters a query reading “I manages rental apartment, and is apartment rent subject to consumption tax?”. The query includes six concepts: “rental apartment”, “manages”, “apartment”, “rent”, “consumption tax”, and “subject to”.

The knowledge graph illustrated in FIG. 4 includes the six concept nodes of “rental apartment”, “manages”, “apartment”, “rent”, “consumption tax”, and “tax liability determination” are acquired as multiple nodes corresponding to the query. One or more labels are attached to each concept node. If a label is included in the query, the concept node is acquired. “rdfs: label” indicates that the concept node includes a label. For example, the concept node “rental apartment” has a label “rental apartment”. One or more relationships are defined between the concept nodes. Concept nodes having no relationship defined are not linked. “subClassOf” indicates that the concept nodes has a relationship of a generic concept or a specific concept. For example, the concept node “apartment” is broader than the concept node “rental apartment”.

Referring to FIG. 4, the six concept nodes of “rental apartment”, “manages”, “apartment”, “rent”, “consumption tax”, and “tax liability determination” are acquired as the multiple nodes corresponding to the query.

The acquisition unit 32 may handle as a search target a content unit having concept nodes of the same number as the number of concepts included in the query. In this way, only content units having a higher possibility of reflecting the intention of the user are selected as search targets from among numerous content units.

The search unit 34 of the exemplary embodiment searches for a path including nodes related to each other from multiple nodes acquired by the acquisition unit 32. The searching for the path uses an algorithm of related art used to address the shortest path problem. The shortest path problem is an optimization problem that is used to determine a path with a minimum weight from among the paths that connect two nodes in a weighted graph. The algorithms to address the shortest path problem include Dijkstra's algorithm, Bellman-Ford algorithm, and Washall-Foyd algorithm.

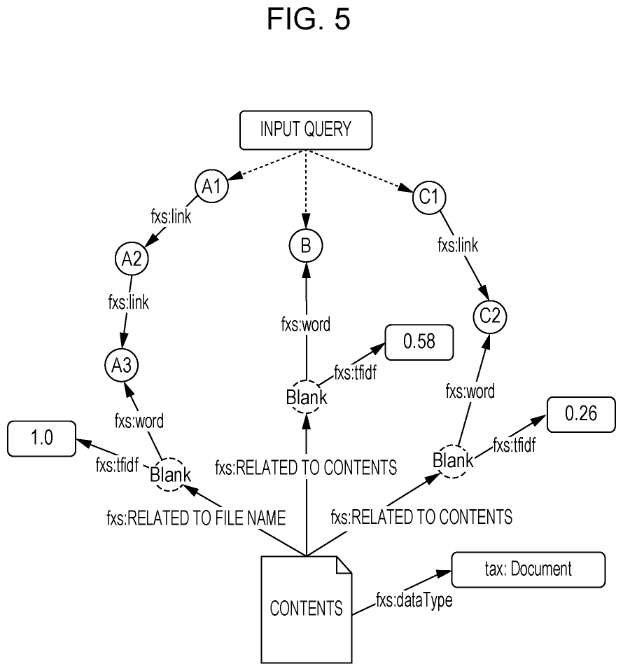

As illustrated in FIG. 5, the calculating unit 36 of the exemplary embodiment calculates a score for a path of at least one content unit searched for and found by the search unit 34. The calculating unit 36 calculates the score by using at least one of a hop count, a degree of importance of a concept of the content unit, and a type of a relationship between the concepts. The hop count represents the number of nodes or the number of edges between the node representing the concept included in the query and the content unit. If the number of paths is plural, the calculating unit 36 calculates the score of the content unit by calculating the score for each of the paths and summing the computed scores.

FIG. 5 illustrates path finding and path assessment of the exemplary embodiment. Referring to FIG. 5, three paths including first through third paths are searched in the knowledge graph of a given content unit in response to an input query. The first path includes concept nodes A1, A2, and A3, the second path includes concept node B, and the third path includes concept nodes C1 and C2.

Referring to FIG. 5, the concept node A1 represents a concept included in the query and the concept node A3 represents a concept included in the content unit. The concept node C1 represents a concept included in the query and the concept node C2 represents a concept included in the content unit. “fxs:link” indicates that a link is present between the concept nodes. “fxs:word” indicates that a word included in the content unit corresponds to the concept node. “fxs:tfidf” indicates that the degree of importance of the concept in the content unit is set up. “fxs:related to file name” indicates that the concept node is related to the file name of the content unit. “fxs:related to content” indicates that the concept node is related to the detail of the content unit. “fxs:dataType” indicates the data type of the content unit.

The degree of importance of the concept node in the content unit is set between the concept node corresponding to a word included in the content unit (the concept nodes A3, B, or C2 in FIG. 5) and the content unit. The degree of importance is calculated by using term frequency (TF)-inverse document frequency (IDF). TF indicates the frequency of appearance of the concept (or word) and IDF indicates the inverse document frequency. The degree of importance is the product of TF and IDF (TF*IDF). As the frequency of appearance of a specific word is higher in a given document, TF of the word is higher and as a word more frequently appears in another document, IDF of the word is lower. TF*IDF serves as an indicator indicating that a given word is a word characteristic of the document. Since multiple language surface layers are assigned as a label in the concept node of the knowledge graph as described above, TF*IDF is calculated on a per concept basis rather than with respect to the surface layer of the word.

For example, the degree of importance Tᵢⱼ in document j of a concept node tᵢ is calculated in accordance with equation (1). Here, nᵢⱼ represents the number of appearances of the language surface assigned to the concept node tᵢ of the document j, Σₖnₖⱼ is the number appearances of the language surfaces assigned to all concept nodes in the document j, |D| represents the number of documents serving as search targets, and |{d:d [symbol] tᵢ}| represents the number of documents, each including the concept node tᵢ.

$${T}_{ij} = \frac{{n}_{ij}}{{\sum }_{k} {n}_{kj}} \cdot ( log \frac{1 + \vert D \vert}{1 + \vert \{ d : d ∋ {t}_{i} \} \vert} + 1 ) \qquad ( 1 )$$

For example, the score Sⱼ for the content unit is calculated in accordance with equation (2) by using the hop count d and the degree of importance Tᵢⱼ. R represents the number of paths, and kₜ and k_{d} represent parameters (constants) for score adjustment.

$${S}_{j} = {\sum }_{R} \frac{{T}_{ij} + {k}_{t}}{d + {k}_{d}} \qquad ( 2 )$$

Specifically, since the hop count d is 2, degree of importance Tᵢⱼ is 1.0, parameter kₜ is 1, and parameter k_{d} is 1 in the first path illustrated in FIG. 5, the score S₁ of the first path is calculated to be S₁=(1.0+1)/(2+1)≈0.67. Similarly, since the hop count d is 0, degree of importance Tᵢⱼ is 0.58, parameter kₜ is 1, and parameter k_{d} is 1 in the second path, the score S₂ of the second path is calculated to be S₂=(0.58+1)/(0+1)=1.58. Similarly, since the hop count d is 1, degree of importance Tᵢⱼ is 0.26, parameter kₜ is 1, and parameter k_{d} is 1 in the third path, the score S₃ of the third path is calculated to be S₃=(0.26+1)/(1+1)=0.63. In this way, the score Sⱼ of the content unit is calculated to be Sⱼ=S₁+S₂+S₃=0.67+1.58+0.63=2.88. In accordance with equation (2), as the hop count is smaller per path and the number of paths included in the content unit is larger, the score of the content unit is calculated to be higher. Specifically, as the hop count is smaller per path and the number of paths included in the content unit is larger, there is a higher possibility that search results reflect user intention.

If the content unit includes a caption, the degree of importance of a concept node included in the caption may be calculated to be higher than the degree of importance of a concept node not included in the caption. The caption means an explanation or a title of the content unit. Since the concept node included in the caption is more important, the degree of importance of the concept node is desirably rated to be higher. A conclusion or a summary is typically written in the latter part of the content unit and the degree of importance of the concept node appearing in the latter part of the content unit may be calculated to be higher than the degree of importance of the concept node in parts other than the latter part of the content unit.

The upper limit on the hop count may be specified by the user. As the upper limit on the hop count is lower, noise involved is lower and the number of paths is smaller. On the other hand, as the upper limit on the hop count is higher, noise involved is higher and the number of paths is larger. If the user prioritizes the reduction of noise, the upper limit on the hop count may be set to be lower. If the user prioritizes an increase in the number of paths, the upper limit on the hop count may be set to be higher. If the user wishes to reduce noise while gaining the number of paths to a certain degree, the upper limit on the hop count may be set to be somewhere between a smaller count and a larger count.

In the example described above, the score of each path is calculated by using the hop count and the degree of importance. The exemplary embodiment is not limited to these factors. The score of the path may be calculated by using only the hop count or by using only the degree of importance.

The calculating unit 36 may calculate the scores of only the content units having an equal number of paths. Since a score may be calculated, for example, for content units having three paths, a variation in the path assessment is controlled.

The calculating unit 36 calculates the score of the path if a specific concept is related to the content unit. If any specific concept is not related to the content unit, it is possible that the score of the path is not calculated. For example, the specific concept may be a technical term. If a technical term is related to the content unit, that content unit may be considered to be an appropriate content unit as search results. The paths are thus desirably assessed regardless of the number of thereof.

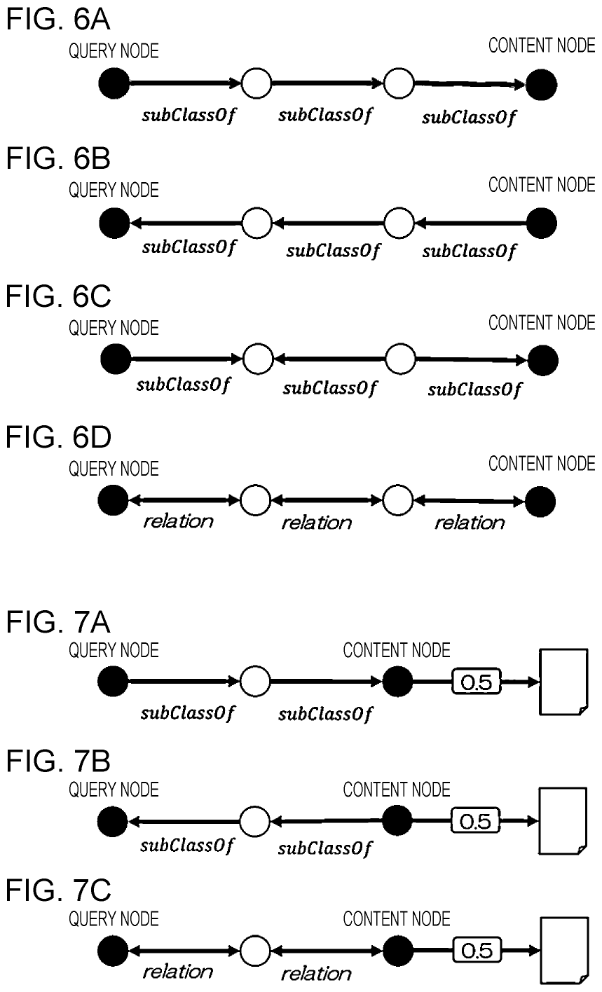

Path search may be performed according to the type of relationship between concepts. The type of relationship between the concepts may include a first type indicating a relationship between a generic concept and a specific concept and a second type indicating a relationship between the generic concept and a concept other than the specific concept. In accordance with the exemplary embodiment, the first type is referred to as “subClassOf” and the second type is referred to as “relation”. Referring to FIGS. 6A through FIG. 6D, the search unit 34 restricts the paths to be searched by restricting the upper limit on the hop count depending on the type of the relationship between the concepts.

FIG. 6A illustrates an example of an abstraction path of the exemplary embodiment. The abstraction path in FIG. 6A includes subClassOf and has a concept node on the side of the content unit (content node) broader than a concept node on the side of the query (query node). The solid circle on the left end in FIG. 6A denotes a query node and the solid circle on the right end in FIG. 6A denotes a content node. The direction each arrow mark indicates a direction from a specific concept to a generic concept. Since too much abstraction causes a distance to be farther from the query, an upper limit is set on the hop count in the abstraction path. The abstraction path having the hop count in excess of the upper limit is excluded from search results.

FIG. 6B illustrates an example of a concretion path of the exemplary embodiment. The concretion path in FIG. 6B includes subClassOf and has a content node narrower than a query node. Even if a desired content unit is more specifically described, no problem arises and no upper limit is set on the hop count in the concretion path.

An upper limit may be set on the hop count in the concretion path but in such a case, the upper limit on the hop count in the concretion path is desirably set to be higher than the upper limit on the hop count in the abstraction path. Specifically, if the hop count in the concretion path is higher than the hop count in the abstraction path, more appropriate search results may be obtained.

FIG. 6C illustrates an example of a mixture path including an abstraction path and a concretion path of the exemplary embodiment. The mixture path in FIG. 6C includes subClassOf and includes both the abstraction path and the concretion path. In this case, an upper limit is set on the hop count in only the abstraction path of the mixture path. The mixture path including the abstraction path having the hop count in excess of the upper limit is excluded from the search results.

FIG. 6D illustrates an example of a relation path of the exemplary embodiment. The relation path in FIG. 6D includes “relation”. An upper limit is set on the hop count in the relation path. A relation path having the hop count in excess of the upper limit is excluded from the search results.

If the hop count is excessively increased, a processing load is also increased. An upper limit is desirably set on the sum of the hop counts per path regardless of the relationship.

The score calculation is performed by accounting for the type of the relationship between the concepts as described below. Referring to FIGS. 7A through 7C, the calculating unit 36 calculates the score of the path by using a distance between the concepts determined in accordance with the type of the relationship of the concepts. Specifically, the score is calculated with the hop count d in equation (2) replaced with a path distance d.

FIG. 7A illustrates a score calculation method for the abstraction path of the exemplary embodiment. For example, in the abstraction path in FIG. 7A, the distance between the concepts (a distance per hop) is set to be 1.2.

In the abstraction path in FIG. 7A, the path distance d=1.2×2=2.4. As an example, the degree of importance Tᵢⱼ is 0.5, parameter kₜ is 1, and parameter k_{d} is 1. The score S of the abstraction path is calculated to be S=(0.5+1)/(2.4+1)≈0.44 in accordance with equation (2).

FIG. 7B illustrates the score calculation method of the concretion path of the exemplary embodiment. In the concretion path in FIG. 7B, the distance between the concepts is set to be 0.8.

In the concretion path in FIG. 7B, the path distance d=0.8×2=1.6. As an example, the degree of importance Tᵢⱼ is 0.5, parameter kₜ is 1, and parameter k_{d} is 1. The score S of the concretion path is calculated to be S=(0.5+1)/(1.6+1)≈0.58 in accordance with equation (2).

FIG. 7C illustrates the score calculation method of the relation path of the exemplary embodiment. In the relation path in FIG. 7C, the distance between the concepts is set to be 1.0.

In the relation path in FIG. 7C, the path distance d=1.0×2=2.0. As an example, the degree of importance Tᵢⱼ is 0.5, parameter kₜ is 1, and parameter k_{d} is 1. The score S of the relation path is calculated to be S=(0.5+1)/(2.0+1)=0.5 in accordance with equation (2).

The distance between the concepts (concept distance) including “subClassOf” is different from the distance between the concepts including “relation.” Specifically, the concept distance of the abstraction path including subClassOf illustrated in FIG. 7A is longer than the concept distance of the relation path including relation illustrated in FIG. 7C. The concept distance of the concretion path including subClassOf illustrated in FIG. 7B is shorter than the concept distance of the relation path including relation illustrated in FIG. 7C.

If the hop count increases, the processing load increases in the same manner as in FIGS. 6A through 6D. A limit is desirably set on the sum of hop counts per path regardless of the relationship.

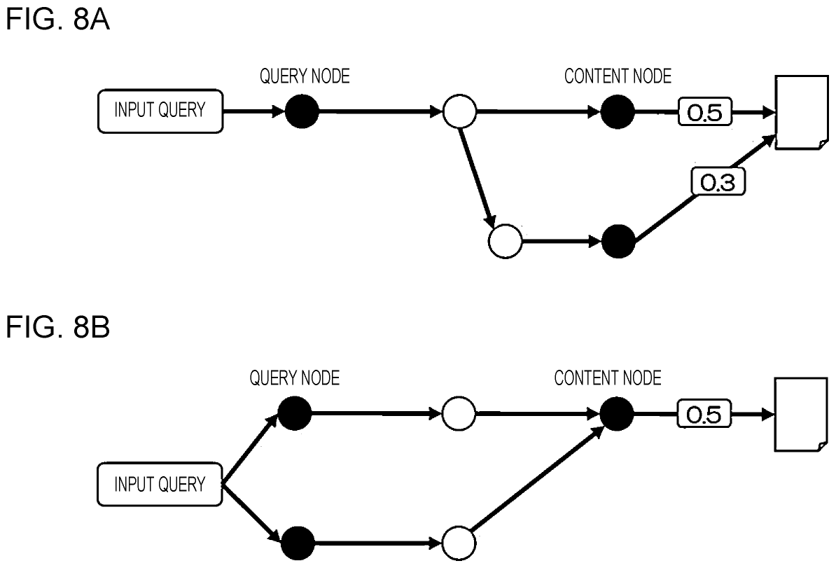

The score may be calculated in view of the branching and merging of paths as described below. As illustrated in FIGS. 8A and 8B, the calculating unit 36 calculates the scores by using a method that is different from a path including a branch path to a path including a merging path.

FIG. 8A illustrates a score calculation method performed to calculate a score of a branch path in accordance with the exemplary embodiment. The branch path in FIG. 8A includes a concept node on the query side that branches to multiple concept nodes on the content side. There is a higher possibility that much description related to the concept node on the query side is included. The score of the path including the branch paths is calculated by summing the scores of the branch paths.

For example, if the hop count d is 2, degree of importance Tᵢⱼ is 0.5, parameter kₜ is 1, and parameter k_{d} is 1 in the branch path on the upper side in FIG. 8A, the score S of the branch path is then calculated to be S=(0.5+1)/(2+1)=0.5 in accordance with equation (2). For example, if the hop count d is 3, degree of importance Tᵢⱼ is 0.3, parameter kₜ is 1, and parameter k_{d} is 1 in the branch path on the lower side in FIG. 8A, the score S of the branch path is then calculated to be S=(0.3+1)/(3+1)≈0.33 in accordance with equation (2). The score S of the path including the two branch paths is thus calculated to be S=0.5+0.33=0.83.

FIG. 8B illustrates the score calculation method of the merging paths of the exemplary embodiment. In the merging paths in FIG. 8B, the multiple nodes on the query side connect to the concept node on the content side via the merging paths. Since the possibility of the query of being redundant is high, a maximum score of the scores of the merging paths is set to be the score of the path including the merging paths.

For example, if the hop count d is 2, degree of importance Tᵢⱼ is 0.5, parameter kₜ is 1, and parameter k_{d} is 1 in the merging path on the upper side in FIG. 8B, the score S of the merging path is then calculated to be S=(0.5+1)/(2+1)=0.5 in accordance with equation (2). Similarly, if the hop count d is 2, degree of importance Tᵢⱼ is 0.5, parameter kₜ is 1, and parameter k_{d} is 1 in the merging path on the lower side in FIG. 8B the score S of the merging path is then calculated to be S=(0.5+1)/(2+1)=0.5 in accordance with equation (2). The scores S of the merging paths equal each other and the maximum score is 0.5. The score S of the path including the two merging paths is thus 0.5.

The calculating unit 36 generates a content list by ranking the content units in the order of high to low scores in accordance with the scores of the content units calculated described above.

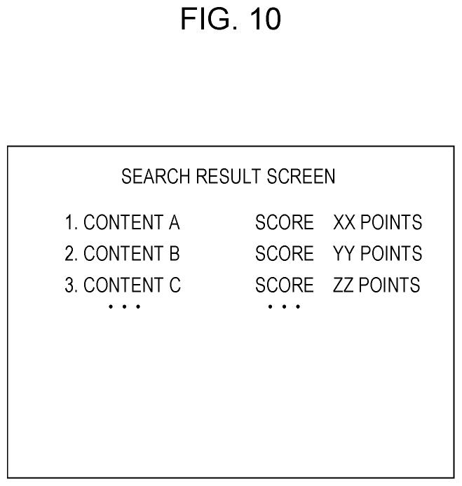

The display controller 38 of the exemplary embodiment performs control to display a search result screen in FIG. 10 on the terminal apparatus 50 in accordance with the content list generated by the calculating unit 36.

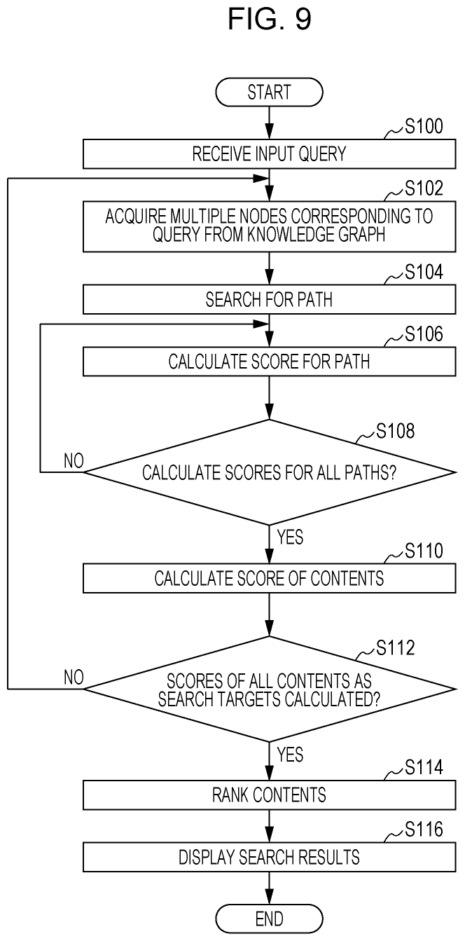

The process performed by the information processing apparatus 10 of the exemplary embodiment is described with reference to FIG. 9.

FIG. 9 is a flowchart illustrating the process based on the path assessment process 14A of the exemplary embodiment.

When the path assessment program 14A is started up on the information processing apparatus 10, operations in the following steps are performed.

In step S100 in FIG. 9, the receiving unit 30 receives the query in FIG. 4 from the terminal apparatus 50 that is being used by the user.

In step S102, on each content unit serving as a search target, the acquisition unit 32 acquires multiple nodes corresponding to the query from the knowledge graph in FIG. 4.

In step S104, the search unit 34 searches for a path including nodes mutually related via edges from the nodes acquired in step S102 as illustrated in FIG. 5.

In step S106, the calculating unit 36 calculates the score of the path searched and found in step S104 by using at least one of the hop count, the degree of importance of the content unit, and the type of the relationship between the concepts. For example, the score is calculated in accordance with equations (1) and (2).

In step S108, the calculating unit 36 determines whether the scores of all paths of the content unit have been calculated. If the calculating unit 36 determines that the scores of all paths of the content unit have been calculated (yes branch), processing advances to step S110. If the calculating unit 36 determines that the scores of all paths of the content unit have not been calculated (no branch), processing returns to step S106 to repeat the operation in step S106 and subsequent operations.

In step S110, the calculating unit 36 calculates the score of the content unit in accordance with equation (2).

In step S112, the calculating unit 36 determines whether the scores of all content units serving as the search targets have been calculated. If the calculating unit 36 determines that the scores of all content units serving as the search targets have been calculated (yes branch), processing proceeds to step S114. If the calculating unit 36 determines that the scores of all content units serving as the search targets have not been calculated (no branch), the calculating unit 36 returns to step S102 to repeat the operation in step S102 and subsequent operations.

In step S114, the calculating unit 36 generates a content list by ranking the content units in the order of high to low scores in accordance with the scores calculated in step S110.

In step S116, the display controller 38 performs control to display the content list generated in step S114 as the search result screen in FIG. 10 on the terminal apparatus 50. The series of operations of the path assessment program 14A is thus completed.

FIG. 10 illustrates the search result screen of the exemplary embodiment. The search result screen in FIG. 10 displays the content list that lists multiple content units obtained as the search results in the order of high to low scores. The search result screen is displayed on the terminal apparatus 50.

In accordance with the exemplary embodiment, the content units relatively closer to the input query are ranked in the path assessment of the content unit by using at least one of the hop count, the degree of importance of the concept in the content unit, and the type of the relationship between the concepts. The user may thus obtain the search results that reflect the user intention.

The information processing apparatus of the exemplary embodiment has been described. The exemplary embodiment may be implemented by a computer program that causes a computer to perform the functions of elements in the information processing apparatus. The exemplary embodiment may also be implemented by a non-transitory computer readable medium that has stored the program.

The configuration of the information processing apparatus has been described as an example. The configuration may be modified as long as the configuration does not depart from the scope of the exemplary embodiment.

The process of the program has been described as an example. A step may be deleted in the process or a new step may be added to the process, or the order of the steps in the process may be modified.

In accordance with the exemplary embodiment, the process of the exemplary embodiment is implemented by a computer that performs the program and is thus implemented by a software configuration. The exemplary embodiment is not limited to this. The exemplary embodiment may be implemented by using a hardware configuration or the combination of the hardware configuration and the software configuration.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a receiving unit that receives a query;
an acquisition unit that acquires, on each content unit serving as a search target, a plurality of nodes corresponding to the query from data that represents a relationship between the nodes and includes information on each node representing a concept of the content unit serving as a search target;
a search unit that searches for a path including nodes mutually related to each other from the nodes acquired by the acquisition unit; and
a calculating unit that calculates a score of the path of at least one of the content units, the path searched and found by the search unit, by using at least one of a hop count representing a number of nodes included between a node representing the concept included in the query and the content unit, a degree of importance of the concept of the content unit, and a type of the relationship of the concepts.

2. The information processing apparatus according to claim 1, wherein if a plurality of paths is present, the calculating unit calculates the score of the content unit by calculating the score of each path and by summing the calculated scores.

3. The information processing apparatus according to claim 2, wherein the calculating unit calculates the scores of only the content units having an equal number of paths.

4. The information processing apparatus according to claim 1, wherein the acquisition unit searches for the content unit, as a search target, related to concepts of a number equal to a number of concepts included in the query.

5. The information processing apparatus according to claim 2, wherein the acquisition unit searches for the content unit, as a search target, related to concepts of a number equal to a number of concepts included in the query.

6. The information processing apparatus according to claim 1, wherein the calculating unit calculates the score of the path if the content unit is related to a particular concept, and
wherein the calculating unit does not calculate the score of the path if the content unit is not related to the particular concept.

7. The information processing apparatus according to claim 1, wherein the type of the relationship of the concepts includes a first type representing a relationship between a generic concept and a specific concept and a second type representing a relationship between the generic concept and a concept other than the specific concept.

8. The information processing apparatus according to claim 7, wherein the path has the first type of the relationship and is an abstraction path having a concept on a side of the content unit broader than a concept on a side of the query, and
wherein the search unit sets an upper limit on the hop count of the abstraction path.

9. The information processing apparatus according to claim 7, wherein the path has the first type of the relationship and is a concretion path having a concept on a side of the content unit narrower than a concept on a side of the query, and
wherein the search unit does not set an upper limit on the hop count of the concretion path.

10. The information processing apparatus according to claim 7, wherein the path has the first type of the relationship and is a mixture path including an abstraction path having a concept on a side of the content unit broader than a concept on a side of the query and a concretion path having a concept on a side of the content unit narrower than a concept on a side of the query, and
wherein the search unit sets an upper limit on only the hop count of the abstraction path of the mixture path.

11. The information processing apparatus according to claim 7, wherein the path is a relation path including the two types of relationship, and
wherein the search unit sets an upper limit on the hop count of the relation path.

12. The information processing apparatus according to claim 1, wherein the calculating unit calculates the score of the path by using a distance between the concepts determined in accordance with the type of the relationship of the concepts,
wherein the type of the relationship of concepts includes a first type representing a relationship between a generic concept and a specific concept and a second type representing a relationship between the generic concept and a concept other than the specific concept, and
wherein the distance between the concepts in a path including the first type of the relationship is different from the distance between the concepts in a relation path including the second type of the relationship.

13. The information processing apparatus according to claim 12, wherein a distance between the concepts in an abstraction path that has the first type of the relationship and has a concept on a side on the content unit broader than a concept on a side of the query is longer than a distance between the concepts in the relation path.

14. The information processing apparatus according to claim 12, wherein a distance between the concepts in a concretion path that has the first type of the relationship and has a concept on a side of the content unit narrower than a concept on a side of the query is shorter than a distance between the concepts in the relation path.

15. The information processing apparatus according to claim 1, wherein the calculating unit calculates the score by using a method that is different from a path including a branch path in which the concept on a side of the query branches into a plurality of concepts on a side of the content unit to a path including a merging path in which a plurality of concepts on a side of the query merges into the concept on a side of the content unit.

16. The information processing apparatus according to claim 15, wherein if the path includes the branch paths, the calculating unit calculates the score of the path by summing scores of the branch paths.

17. The information processing apparatus according to claim 15, wherein if the path includes the merging paths, the calculating unit sets a maximum score of the scores of the merging paths to be the score of the path.

18. The information processing apparatus according to claim 1, wherein the degree of importance is calculated by using term frequency-inverse document frequency (TF-IDF).

19. The information processing apparatus according to claim 18, wherein if the content unit includes a caption, the degree of importance of a concept included in the caption is calculated to be higher than the degree of importance of a concept not included in the caption.

20. A non-transitory computer readable medium storing a program causing a computer to execute a process for processing information, the process comprising:
receiving a query;
acquiring, on each content unit serving as a search target, a plurality of nodes corresponding to the query from data that represents a relationship between the nodes and includes information on each node representing a concept of the content unit serving as a search target;
searching for a path including the nodes mutually related to each other from the acquired nodes; and
calculating a score of the searched and found path of at least one of the content units by using at least one of a hop count representing a number of nodes included between a node representing the concept included in the query and the content unit, a degree of importance of the concept of the content unit, and a type of the relationship of the concepts.
